(19) United States
(12) Patent Application Publication
(10) Pub. No.: US 2024/0051286 A1
(43) Pub. Date: Feb. 15, 2024

(54) TEMPERATURE CONTROL STRUCTURE OF LAMINATOR

(71) Applicant: Jingang XIE, Xianning (CN)

(72) Inventor: Jingang XIE, Xianning (CN)

(21) Appl. No.: 18/358,905

(22) Filed: Jul. 25, 2023

(30) Foreign Application Priority Data
Aug. 10, 2022 (CN) 202222096758.2

(51) Int. Cl. B32B 41/00; B32B 37/00

(52) U.S. Cl. CPC B32B 41/00; B32B 37/0053; B32B 2309/02

(57) ABSTRACT

The present application relates to the technical field of office facilities, in particular to a temperature control structure of a laminator. According to the temperature control structure of the present application, by means of the temperature transfer shaft sleeve, the temperature transfer shaft sleeve can sense the temperature of the upper laminating roller in time so as to transfer the temperature to the temperature controller in time, and then the temperature controller controls the heating elements to be turned on or off, so that temperature control can be relatively accurate. The temperature fuse with a silicon fiber casing tube is also installed on the temperature transfer shaft sleeve, so as to achieve the effect of turning off the heating elements at a certain high temperature when the temperature controller is out of control and cannot stop heating due to other reasons.

### CROSS-REFERENCE TO RELATED APPLICATIONS

The application claims priority to Chinese patent application No. 202222096758.2, filed on Aug. 10, 2022, the entire contents of which are incorporated herein by reference.

### TECHNICAL FIELD

The present application relates to the technical field of office facilities, in particular to a temperature control structure of a laminator.

### BACKGROUND

In existing internal heating laminators, heating elements such as quartz tubes or PTC are arranged in laminating rollers of the laminators. The heating elements are used for providing heat to metal parts of the laminating rollers, and then the heat is transferred to silicone parts of the laminating rollers by the metal parts. During temperature control, temperature controllers can only control the temperature of aluminum heating plates on the laminating rollers, and the temperature of the aluminum heating plates is obtained by radiating the heat of the laminating rollers and transferring the heat of surrounding hot air, rather than directly controlling the temperature of the silicone parts of the laminating rollers. Because the heating elements are arranged in the laminating rollers and the temperature controllers are generally installed on the aluminum heating plates of the laminating rollers, the temperature control is not accurate enough, further affecting the laminating quality of the laminators.

### SUMMARY

In order to overcome the disadvantages and shortcomings of the prior art, the purpose of the present application is to provide a temperature control structure of a laminator.

The purpose of the present application is achieved through the following technical solutions. A temperature control structure of a laminator includes an upper laminating roller and a lower laminating roller. The upper laminating roller and the lower laminating roller are pressed up and down and are capable of rotating synchronously and cooperatively in opposite directions, the upper laminating roller and the lower laminating roller are tubular bodies having cavities, and insides of the tubular bodies having cavities are fixedly provided with heating elements. An outer side of the upper laminating roller is sleeved with a temperature transfer shaft sleeve, a gap is formed between an outer side wall of the upper laminating roller and an inner side wall of the temperature transfer shaft sleeve, the top of the temperature transfer shaft sleeve is fixedly provided with a temperature controller, a temperature fuse with a silicon fiber casing tube is installed on one side of the temperature transfer shaft sleeve, and the temperature fuse is electrically connected to the temperature controller.

Further, the gap between the outer side wall of the upper laminating roller and the inner side wall of the temperature transfer shaft sleeve is 0.2-0.4 mm.

Further, one side of the temperature transfer shaft sleeve is provided with an arc-shaped groove, and the temperature fuse with a silicon fiber casing tube is sleeved in the arc-shaped groove.

Further, two sides of the bottom of the temperature controller are fixedly provided with mounting plates, and the mounting plates are fixed to the top of the temperature transfer shaft sleeve through bolts.

Further, the temperature control structure further includes a bottom shell and an upper cover installed at the top of the bottom shell, a mounting groove is formed in a position, corresponding to the temperature controller, at the bottom of the upper cover, and the top of the temperature controller is embedded in the mounting groove.

Further, the temperature control structure further includes a left support and a right support fixed to two sides of the top of the bottom shell, and two sides of the upper laminating roller and the lower laminating roller are fixed to the left support and the right support respectively.

Further, a driving assembly is installed on a right side of the right support, the driving assembly includes a motor, an output gear fixed to an output end of the motor, a first transmission gear fixed to a right side of the upper laminating roller and a second transmission gear fixed to a right side of the lower laminating roller, and the first transmission gear is separately engaged with the output gear and the second transmission gear.

Further, a paper press plate is installed at a position, corresponding to a paper outlet, between the left support and the right support.

Further, the length of the temperature transfer shaft sleeve is equal to the distance between the left support and the right support.

Further, the temperature transfer shaft sleeve is made of aluminum.

The present application has the following beneficial effects. According to the temperature control structure of the present application, by means of the temperature transfer shaft sleeve, a gap is formed between the outer side wall of the upper laminating roller and the inner side wall of the temperature transfer shaft sleeve. When a laminating roller is heated to a laminating temperature, the laminating roller is expanded, and the outer diameter is increased. At this time, when the upper laminating roller rotates in the temperature transfer shaft sleeve, a cooperative gap therebetween is extremely small or is zero, the temperature transfer shaft sleeve can sense the temperature of the upper laminating roller in time so as to transfer the temperature to the temperature controller in time, and then the temperature controller controls the heating elements to be turned on or off, so that temperature control can be relatively accurate. The temperature fuse with a silicon fiber casing tube is also installed on the temperature transfer shaft sleeve, so as to achieve the effect of turning off the heating elements at a certain high temperature when the temperature controller is out of control and cannot stop heating due to other reasons. The temperature control structure is simple in structure and convenient to use.

### BRIEF DESCRIPTION OF DRAWINGS

FIG. 1 is a schematic diagram of a stereoscopic structure of a laminator in the present application.

FIG. 2 is a schematic diagram of a decomposed stereoscopic structure of the laminator in the present application.

FIG. 3 is a schematic diagram of a stereoscopic structure of an upper cover in the present application.

FIG. 4 shows schematic diagrams of stereoscopic structures of a temperature transfer shaft sleeve, a temperature controller and a temperature fuse in Example 1 of the present application.

FIG. 5 is a schematic diagram of a stereoscopic structure of a temperature transfer shaft sleeve in Example 2 of the present application.

Callouts in the drawings are as follows: upper laminating roller 1, lower laminating roller 2, heating element 3, temperature transfer shaft sleeve 4, arc-shaped groove 41, temperature controller 5, mounting plate 51, bolt 52, temperature fuse 6, bottom shell 7, left support 71, right support 72, motor 73, output gear 74, first transmission gear 75, second transmission gear 76, paper press plate 77, upper cover 8, and mounting groove 81.

### DETAILED DESCRIPTION OF THE EMBODIMENTS

In order to provide convenience for persons skilled in the art to understand the present application, the present application is further described below in combination with examples and the attached drawings 1 to 5, and contents mentioned in embodiments are not intended to limit the present application.

### Example 1

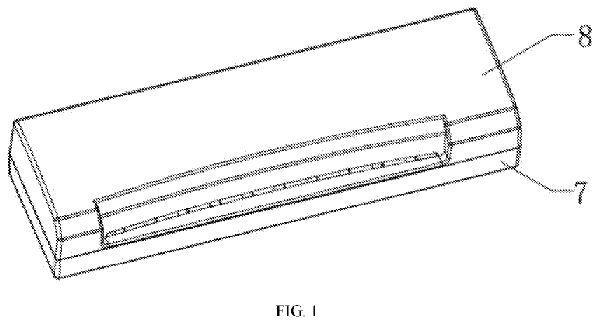

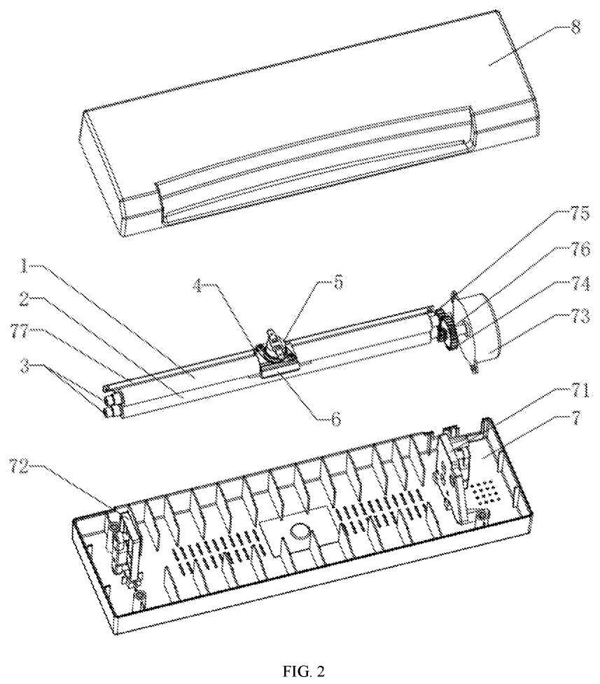

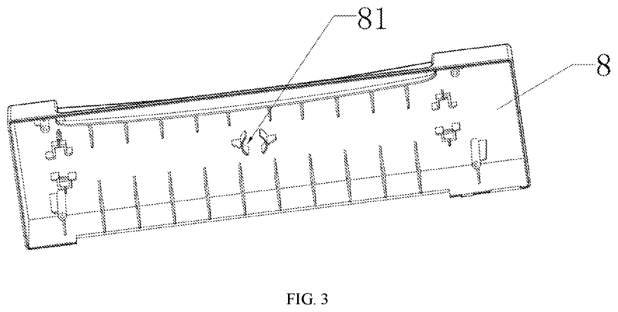

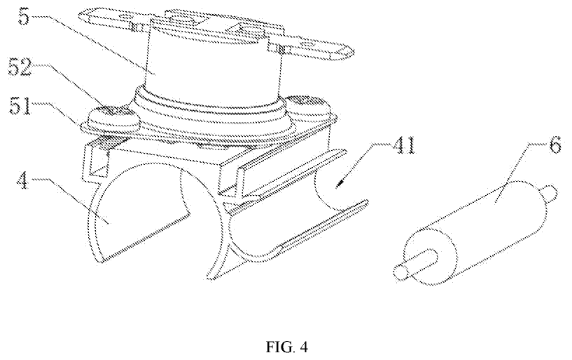

As shown in FIG. 1 to FIG. 4, a temperature control structure of a laminator includes an upper laminating roller 1 and a lower laminating roller 2. The upper laminating roller 1 and the lower laminating roller 2 are pressed up and down and are capable of rotating synchronously and cooperatively in opposite directions, the upper laminating roller 1 and the lower laminating roller 2 are tubular bodies having cavities, and insides of the tubular bodies having cavities are fixedly provided with heating elements 3. An outer side of the upper laminating roller 1 is sleeved with a temperature transfer shaft sleeve 4, a gap is formed between an outer side wall of the upper laminating roller 1 and an inner side wall of the temperature transfer shaft sleeve 4, the top of the temperature transfer shaft sleeve 4 is fixedly provided with a temperature controller 5, a temperature fuse 6 with a silicon fiber casing tube is installed on one side of the temperature transfer shaft sleeve 4, and the temperature fuse 6 is electrically connected to the temperature controller 5.

According to the temperature control structure of the present application, by means of the temperature transfer shaft sleeve 4, a gap is formed between the outer side wall of the upper laminating roller 1 and the inner side wall of the temperature transfer shaft sleeve 4. When a laminating roller is heated to a laminating temperature, the laminating roller is expanded, and the outer diameter is increased. At this time, when the upper laminating roller 1 rotates in the temperature transfer shaft sleeve 4, a cooperative gap therebetween is extremely small or is zero, the temperature transfer shaft sleeve 4 can sense the temperature of the upper laminating roller 1 in time so as to transfer the temperature to the temperature controller 5 in time, and then the temperature controller 5 controls the heating elements 3 to be turned on or off, so that temperature control can be relatively accurate. The temperature fuse 6 with a silicon fiber casing tube is also installed on the temperature transfer shaft sleeve 4, so as to achieve the effect of turning off the heating elements 3 at a certain high temperature when the temperature controller 5 is out of control and cannot stop heating due to other reasons. The temperature control structure is simple in structure and convenient to use.

In the present example, the gap between the outer side wall of the upper laminating roller 1 and the inner side wall of the temperature transfer shaft sleeve 4 is 0.1-0.2 mm. In order to make the present application achieve an optimal use effect, the gap between the outer side wall of the upper laminating roller 1 and the inner side wall of the temperature transfer shaft sleeve 4 is 0.15 mm. The inner diameter of the temperature transfer shaft sleeve 4 is about 0.3 mm greater than the outer diameter of a laminating roller. When a laminating roller is heated to a laminating temperature, the laminating roller is expanded. The expansion size of a silicone part of the laminating roller after being heated is associated with the thickness and temperature of the silicone part. When the thickness of the silicone part is greater, the expansion size is greater; and when the set temperature is higher, the expansion size is also greater. The outer diameter is usually about 0.3 mm greater than an original value. At this time, when the laminating roller rotates in the temperature transfer shaft sleeve 4, a cooperative gap therebetween is extremely small or is zero, and the temperature transfer shaft sleeve 4 can sense the temperature of the laminating roller in time so as to transfer the temperature to the temperature controller 5 in time.

In the present example, one side of the temperature transfer shaft sleeve 4 is provided with an arc-shaped groove 41, and the temperature fuse 6 with a silicon fiber casing tube is sleeved in the arc-shaped groove 41. Through arrangement of the above structure, convenience is provided for installing and disassembling the temperature fuse 6.

In the present example, two sides of the bottom of the temperature controller 5 are fixedly provided with mounting plates 51, and the mounting plates 51 are fixed to the top of the temperature transfer shaft sleeve 4 through bolts 52. Through arrangement of the above structure, convenience is provided for installing and disassembling the temperature controller 5.

In the present example, the temperature control structure further includes a bottom shell 7 and an upper cover 8 installed at the top of the bottom shell 7, a mounting groove 81 is formed in a position, corresponding to the temperature controller 5, at the bottom of the upper cover 8, and the top of the temperature controller 5 is embedded in the mounting groove 81. The temperature controller 5 is sleeved on the upper laminating roller 1 and limited in the upper cover 8, which is not fixed and undergoes adaptive micro-movement, so as to prevent the situation that torque required by a motor is increased by too tight contact between the temperature controller and a laminating shaft.

In the present example, the temperature control structure further includes a left support 71 and a right support 72 fixed to two sides of the top of the bottom shell 7, and two sides of the upper laminating roller 1 and the lower laminating roller 2 are fixed to the left support 71 and the right support 72 respectively.

In the present example, a driving assembly is installed on a right side of the right support 72, the driving assembly includes a motor 73, an output gear 74 fixed to an output end of the motor 73, a first transmission gear 75 fixed to a right side of the upper laminating roller 1 and a second transmission gear 76 fixed to a right side of the lower laminating roller 2, and the first transmission gear 75 is separately engaged with the output gear 74 and the second transmission gear 76. The driving assembly drives the upper laminating roller 1 and the lower laminating roller 2 to rotate synchronously in opposite directions.

In the present example, a paper press plate 77 is installed at a position, corresponding to a paper outlet, between the left support 71 and the right support 72. The paper press plate 77 is separately fixed to the left support 71 and the right support 72 by two screws.

In the present example, the temperature transfer shaft sleeve 4 is made of aluminum. The material of the temperature transfer shaft sleeve 4 mainly includes aluminum, but is not limited to aluminum, and in principle, is a material excellent in heat conduction and convenient to produce and process.

The temperature controller 5 of the present application is not limited to a circular temperature controller 5 as shown in the figure, other temperature controllers 5, such as a flat temperature controller 5, may also be used, and other temperature controllers 5 are used by simply adjusting an installation structure of the temperature controller 5. A temperature control module composed of the temperature controller 5, the temperature transfer shaft sleeve 4 and other parts is not limited to being sleeved on an upper laminating shaft and limited in the upper cover 8, and may also be sleeved on a lower laminating shaft and limited in the lower cover and other positions.

### Example 2

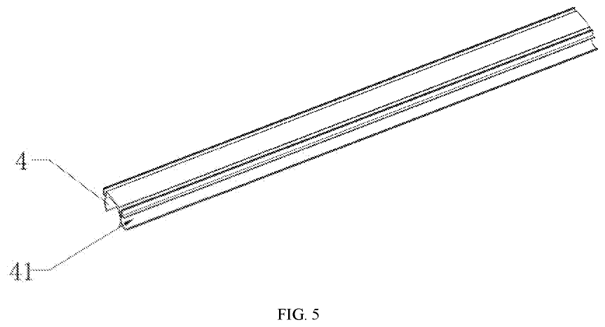

As shown in FIG. 5, the difference between the present example and Example 1 is that the length of the temperature transfer shaft sleeve 4 is equal to the distance between the left support 71 and the right support 72. The length of the temperature transfer shaft sleeve 4 is not limited. In order to achieve a better heat preservation effect and improve the laminating quality, the temperature transfer shaft sleeve may also be made in a length equal to a side distance between the left support 71 and the right support 72 and is limited on the left support 71 and the right support 72.

The above examples are preferred implementation solutions of the present application. In addition, the present application may also be implemented in other ways, and any obvious substitutions made without departing from the concept of the present application fall within the protection scope of the present application.

What is claimed is:

1. A temperature control structure of a laminator, comprising an upper laminating roller and a lower laminating roller, wherein the upper laminating roller and the lower laminating roller are pressed up and down and being capable of rotating synchronously and cooperatively in opposite directions, the upper laminating roller and the lower laminating roller are tubular bodies having cavities, and insides of the tubular bodies having cavities are fixedly provided with heating elements; and an outer side of the upper laminating roller is sleeved with a temperature transfer shaft sleeve, a gap is formed between an outer side wall of the upper laminating roller and an inner side wall of the temperature transfer shaft sleeve, the top of the temperature transfer shaft sleeve is fixedly provided with a temperature controller, a temperature fuse with a silicon fiber casing tube is installed on one side of the temperature transfer shaft sleeve, and the temperature fuse is electrically connected to the temperature controller.

2. The temperature control structure of a laminator according to claim 1, wherein the gap between the outer side wall of the upper laminating roller and the inner side wall of the temperature transfer shaft sleeve is 0.1-0.2 mm.

3. The temperature control structure of a laminator according to claim 1, wherein one side of the temperature transfer shaft sleeve is provided with an arc-shaped groove, and the temperature fuse with a silicon fiber casing tube is sleeved in the arc-shaped groove.

4. The temperature control structure of a laminator according to claim 1, wherein two sides of the bottom of the temperature controller are fixedly provided with mounting plates, and the mounting plates are fixed to the top of the temperature transfer shaft sleeve through bolts.

5. The temperature control structure of a laminator according to claim 1, further comprising a bottom shell and an upper cover installed at the top of the bottom shell, wherein a mounting groove is formed in a position, corresponding to the temperature controller, at the bottom of the upper cover, and the top of the temperature controller is embedded in the mounting groove.

6. The temperature control structure of a laminator according to claim 5, further comprising a left support and a right support fixed to two sides of the top of the bottom shell, wherein two sides of the upper laminating roller and the lower laminating roller are fixed to the left support and the right support respectively.

7. The temperature control structure of a laminator according to claim 6, wherein a driving assembly is installed on a right side of the right support, the driving assembly comprises a motor, an output gear fixed to an output end of the motor, a first transmission gear fixed to a right side of the upper laminating roller and a second transmission gear fixed to a right side of the lower laminating roller, and the first transmission gear is separately engaged with the output gear and the second transmission gear.

8. The temperature control structure of a laminator according to claim 6, wherein a paper press plate is installed at a position, corresponding to a paper outlet, between the left support and the right support.

9. The temperature control structure of a laminator according to claim 6, wherein the length of the temperature transfer shaft sleeve is equal to the distance between the left support and the right support.

10. The temperature control structure of a laminator according to claim 1, wherein the temperature transfer shaft sleeve is made of aluminum.
